(19) United States
(12) Patent Application Publication
(10) Pub. No.: US 2010/0223245 A1
(43) Pub. Date: Sep. 2, 2010

(54) UNIVERSAL LOST AND FOUND TRACKING SYSTEM AND METHOD

(75) Inventor: John Ware Vermilye, Crans-pres-Celigny (CH)

Correspondence Address: SEYFARTH SHAW LLP, WORLD TRADE CENTER EAST, TWO SEAPORT LANE, SUITE 300, BOSTON, MA, 02210-2028, US

(73) Assignee: Travel Sentry, Inc., Durham, NH (US)

(21) Appl. No.: 12/707,980

(22) Filed: Feb. 18, 2010

Related U.S. Application Data
(60) Provisional application No. 61/155,929, filed on Feb. 27, 2009.

(51) Int. Cl. G06F 17/30

(52) U.S. Cl. 707/706; 707/803; 707/783; 707/E17.005; 707/E17.014; 707/E17.044

(57) ABSTRACT

A system and method for identification whereby owners of personal items of value can register against a unique identification number (UID) that is printed, etched or affixed to one or more items. Institutional lost and found offices, such as airline, airport, transit and hotels, and individual finders can use the inventive system to automatically reconcile the lost item by what of its UID and notify the owners or users through an online reporting system. The system and method supplements existing airport luggage tracking systems and more particularly pertains to a new luggage locating system for identification of lost items and a method of automatically identifying the owner of lost items.

### FIELD OF THE INVENTION

The present invention relates to a method of an identification service whereby owners of personal items of value can register against a unique identification number (UID) which is printed, etched or affixed to one or more items. Institutional lost and found offices, such as airline, airport, transit and hotels, and individual finders can use the system to automatically reconcile the lost item UID and notify the owner through an online reporting system.

### BACKGROUND OF THE INVENTION

In common carrier passenger terminals, such as airline, train, bus, marine or other transportation terminals, or at hotels or other facilities where owner-passengers check luggage at a first locus for later retrieval at a second locus there is a need for reliable and flexible luggage handling. That is, luggage must be routed for appropriate loading for transport. It is absolutely necessary for efficient transit systems that luggage reach the proper destination. Unfortunately, despite advanced luggage handling systems, lost or misplaced luggage continues to be a problem for travelers. Disruptions in normal luggage handling involves such situations in which a gate or other embarkation locus changes, or an owner-passenger's itinerary changes, these disruptions often cause luggage to be misplaced or lost and be found within global systems that still depend upon identification methods that are outdated and not successful in locating the owner of lost luggage.

The present invention relates generally to systems and methods for identifying lost or misplaced items and to supplement asset locating systems. The use of numerous approaches to airport luggage tracking systems is known in the prior art. U.S. Pat. No. 6,108,636 has a luggage handling and reconciliation system with biometrics input device positioned in the luggage for collecting biometric data of the holder of the bag and comparing that information with data collected upon entrance to the plane to identify that the user has entered the plane and the luggage can be loaded thereby possibly preventing the misplacement of a passenger's luggage. U.S. Pat. No. 5,650,768 has an automatic baggage claiming apparatus to control access to a secured baggage area to compare identifying baggage code with an identifying claim code to allow the passenger to collect only the correct baggage. Despite these and other prior art approaches, these devices and methods fail when the lost luggage or article lacks proper identification independent of common industry practices and these prior art methods and devices.

Recent attempts to manage and identify lost luggage employ methods such as Radio Frequency Identification (“RFID”), which is presently in use today to locate property and track shipment of goods. Unfortunately, RFID systems are expensive and not easily adapted in a global system. Because of its expense, the use of RFID technology is restricted to property that is typically critical use or expensive items that are otherwise difficult or labor intensive to locate. Existing RFID systems typically include transceivers and a computer or PC based application. The RFID transceivers use signal strength and round trip timing to get a rough triangulation of an article tagged with a RFID tag. Unfortunately, only limited article location capability is provided by existing RFID systems on a global basis.

Additional problems with RFID technology is that transmitter devices for use on luggage heretofore have generally suffered from one or more serious drawbacks, most notably bulkiness, lack of common international standards such as the transmitting and receiving frequency, global adaptability and high cost. Additionally, large expensive identification devices are not conducive to dual use, for instance, the physical combination of the transmitter with traditional visual or more recent electronic optical identification labels.

There are multiple applications for registering and tracking items of value using a Unique Identifier (“UID”) concept. However none of these has been developed to be global, to work in multiple languages, to work for any item or article, to be fully automated without intervention of a call center or service bureau and none has been expressly designed from the perspective of the professional lost and found offices which deal with the vast majority of found items. Unfortunately, none of these prior art methods and devices is built on a model of making the UID, the registration service and the notification of found items low cost or free of charge to the users.

Accordingly, a need remains for an identification tag having a UID that is inexpensive, reliable on a global basis, and is adaptable to be utilized in conjunction with existing infrastructure in order to be integrated within existing visual and/or optical tag device tracking methods.

### SUMMARY OF THE INVENTION

The present invention addresses the problem of lost or misplaced articles including but not limited to transit systems and common carriers. The method of the invention is characterized by an identification service whereby owners of personal items of value can register against a unique identification number (UID) which is printed, etched or affixed to one or more items. Institutional lost and found offices, such as airline, airport, transit and hotels, and individual finders can use the system to automatically reconcile the lost item UID and notify the owner through an online reporting system. The present invention supplements existing airport luggage tracking systems and more particularly pertains to a new luggage locating system for facilitating location of lost or misplaced luggage.

The present invention provides for a novel and improved identification tag having an UID and method of tracking baggage at transportation and shipping facilities which is highly efficient and reliable to use, and which is capable of containing an identifier having a code unique to each article of luggage and passenger associated with that luggage which can be deciphered globally over a broad range, is inexpensive and can be integrated into existing tag devices.

The present invention provides for a novel and improved system and method for identifying luggage which is extremely versatile and conformable for use in combination with existing luggage identification systems and in a way such as to enable continuous identification during all stages of the movement and transfer of luggage at various transportation facilities.

The present invention provides a UID identification system that can be an included item including but not limited to checked and carry-on luggage, portable electronic devices such as laptop computers, PDAs, mobile phones, portable music players and key chains, glasses and glasses cases, agendas, portfolios and address books, briefcases, personal medical devices and other items of value and importance which are subject to being lost or left behind during travel or daily life.

According to illustrative embodiments of the invention the UID is constructed against an algorithm which is comprised of four elements: a manufacturers or issuers code; an item identifier (such as a specific model of laptop computer or luggage); a serial number; and check digits and/or characters. The present invention optionally provides the owner or user of the UID with a personal identification number (“PIN”) that allows the holder of a UID to control the release of the information found within the UID. In particular, this PIN would toggle on or off the availability of data to people within the luggage handling business. For example, a user can opt to release information globally for all registered items (UIDs), or individually for specific registered items (UIDs). In addition, the information that can be released could also include a description of the item (brand and model number and potentially more depending on what information has been registered by the owner). It is contemplated within the scope of the invention that the availability of data may be restricted until such time as the owner of the luggage has activated the data by the use of the PIN upon their luggage being misplaced or lost. The PIN would prevent dishonest baggage handling people from being able to determine the contents of luggage by inquiry into the data information for luggage that is merely in route to a destination but not misplaced or lost.

According to the invention, a UID may be constructed via an algorithm, related to data content and structure, which provides the owner or user a method of identification that is controllable and yet allows the user to provide detailed inventory of packages and luggage.

Advantageously, the present invention provides for a novel and improved identification tag characterized by a UID that can be utilized alone or in association with other indicia on the tag to identify a passenger's luggage as well as other pertinent information between different given departure and arrival points.

The UID according to the invention can allow users such as corporations, governments or other organizations to track laptops, mobile phones and other items of value. Further, it can allow manufacturers of consumer products to provide purchasers with an UID that can be activated upon registration of ownership thereby allowing manufactures to use a UID as a value-added feature to their products (such as electronics and luggage manufacturers).

The system and method of the invention provides a UID having an online registration service for owners that may be available in multiple languages and designed for both individual and corporate users and which can also be used as an online inventory of registered items for insurance purposes.

It allows for an online registration service for “institutional” lost and found offices, “frequent finders” making the reporting of found items fast and efficient. The UID according to the invention allows online reporting for any finder that records the location of the found item is and how it can be retrieved in an automatic texting, email or voicemail system in which information is generated in a message to the owner in a manner that does not disclose owner information to the finder of lost articles thereby protecting the privacy of the owner.

### BRIEF DESCRIPTION OF THE DRAWINGS

Some or all of the above and other objects, advantages and features of the present invention will become more readily appreciated and understood from a consideration of the following detailed description of illustrative and modified forms of the present invention when taken together with the accompanying drawings in which:

FIG. 1 is an illustration of a UID tag for use according to the invention;

FIG. 2 is a diagram illustrating a distributed digital data processing system environment according to an illustrative embodiment of the invention; and

FIG. 3 is a schematic representation of the UID according to the invention;

### DETAILED DESCRIPTION

The apparatus and methods of the present invention comprise an identification tag or imprint upon an article that reliably identifies the owner and inventory of at least one article. The tag or imprint contains at least one UID according to the invention that is decipherable by digital data processors, thereby permitting automated evaluation of various aspects of the UID, e.g., identity of owner, contents, etc.). In one illustrative embodiment the intended use of the inventive identification tag or imprint having an UID is in conjunction with global common carriers such as airplanes, and their associated terminals and baggage transportation systems. It is also contemplated within the scope of the invention that the UID according to the invention can be used to track and/or provide an inventory of packages, containers or like articles within the parcel post or shipping industries. In this disclosure, airline industry is used to denote any mode of mass carriage of cargo, especially people, and is intended to include, without limitation, passenger planes, buses, maritime transport and trains.

The identification tag containing the inventive UID is affixed to luggage or imprinted upon an article, to assure that luggage or articles and passengers are properly routed, or recovered and redirected when lost. It may become apparent to those skilled in the art that the inventive identification tag finds useful application outside the mass transportation industry, and may find beneficial use wherever reliable identification and tracking of movable objects or persons is desired.

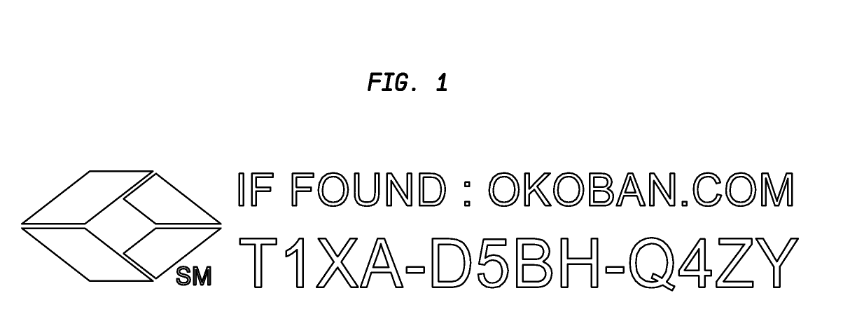

The identification tag, such as illustrated in FIG. 1 having the inventive UID can be in the form of a conventional identification tag or it can be imprinted upon the article needing identification. The identification tag can also include a securing mechanism for securing the label to an item, location, or any other suitable support. The identification tag can be secured to an item or at a location according to many known mechanical and non-mechanical fastening techniques such as a securing adhesive. The securing adhesive can be an adhesive backing or a suitable adhesive, or can generally represent securing the identification tag to an item or support by fasteners, stitching, weaving, sewing, laminating, snapping, pinning, tacking, loop and hook-type arrangements, and clipping and the like. The securing adhesive can also be temporarily or permanently attached to the item, or formed partly or wholly from the item or identification tag. The identification tag containing the inventive UID can be integrally formed with the item or location or formed from or is the same raw stock or material of the item, and hence need not employ any securing means.

In accordance with the invention the UID is comprised of a unique identification number constructed against an algorithm having at least the following elements: a manufacturers or issuers code; an item identifier (such as a specific model of laptop computer or luggage, etc.); a serial number; and check digits and/or characters. These elements are connected with the owner's identification and related contact information within a generated identification record.

The inventive UID generated against the algorithm is unique to an article thereby causing each article affixed with a tag or imprint containing the UID to be unique and identifiable. Every generated UID is contained within a central database operated by a central records agency and is associated with all of the elements mentioned above that is unique to the owner or user of the UID. The generated UID is of variable length and construction. It can be comprised of numbers, letters, words, symbols, colors or mixtures thereof. All or a portion of the UID is randomly generated by the algorithm described above and is unique to a corresponding identification record stored within a database.

A format of a UID according to an illustrative embodiment, is: CPPC URUU UKUU, where;

C is Company;

P is Product;

R is Reserve;

U is UID;

K is checksum.

Company may be the manufacturer or other source company. For luggage the Product code is optionally composed of baggage type (0-9) and color (single alpha) based on the new Simplified Baggage Identification Chart developed by Travel Sentry which maps back to the “Traditional” ATA/IATA Baggage Identification Chart.

Illustratively, the UID “number” itself is comprised of digits 0-9 and case insensitive alphabet, A-Z and may or may not exclude vowels. The UID number can be created by any of various algorithms, but in an illustrative embodiment the UID may be based on a first number that may be a function of some characteristic, e.g. time or place/location of creation. Some consideration should be made so that UID numbers are not repeated between different companies.

A second number, or any number of other numbers, may be used in formulating the UID. Such a second number may be based on other characteristics, including but not limited to company, model, a first number, quantity of numbers, or the like.

The first and at least a second number may be used to calculate a list of numbers for a given company/product and they may be used to calculate a checksum.

The identification record, maintained in a database which corresponds to the UID, contains multiple fields of data including the contact information of the owner or user of the UID. It may further contain an inventory or specific description of the article associated with the UID. According to the invention, activation or access to the identification record can be optionally toggle on or off by the use of a specific personal identification number (PIN) that is generated by the owner or user of the UID. The PIN feature of the inventive UID provides privacy and control to the owner or user of the UID. It can also provide varying levels of privacy allowing the owner or user of the UID to allow access to the complete identification record or to selected fields within the identification record.

The UID can be pre-generated by manufacturers of consumer articles prior to the identification record being completed. It is contemplated within the scope of the invention that the identification record can be completed with a web based online registration service for owners or users available in multiple languages and designed for both individual and corporate users. The online registration can allow changes to the identification record, which can also facilitate an online inventory of registered items for insurance purposes. It is further contemplated within the scope of the invention that the identification record can be created or updated via regular mail registration or the like.

It is also contemplated within the scope of the invention that the online identification record can be accessed by “institutional” lost and found offices, police departments, and security agencies, which makes reporting found items by “frequent finders” fast and efficient. According to one aspect of the invention, the owner or user of the UID can toggle on or off the ability of frequent finders to directly access the identity of the owner or selected fields of the identification record.

According to a further aspect of the invention, the UID can be part of or comprise an airline check-in procedure and can be an additional identifier utilized within any airline, travel industry or common carrier check-in procedure including but not limited to baggage check-in kiosk, skycap check-in station, boarding gate, departure door, airplane boarding ramp, automated baggage handling system, portable baggage ramp conveyor belts on trucks, cargo/baggage doors of an airplane, transfer point on baggage conveyor belt, intersection of baggage conveyor belts, reading stations on baggage conveyor belts, baggage pick up conveyor carousels, door ways, security check points, ship hatches, cabins, ship loading ramps (gangways), cargo/luggage storage holds, luggage compartments, hotel check-in counters, bell stands, bus luggage compartments, tractor trailer loading docks, tractor trailer loading doors, post office clerk windows, delivery person, pick up person, deliver truck, pickup truck, walk up manned mailing window, walk up unmanned mailing window/drop off boxes, drive up mailing window/drop off, self standing overnight mailing kiosks, mail boxes, drop boxes, automated parcel moving system, automated mail sorting systems, automated postage canceling system, automated postage affixing system, cars trucks, turnstile, doorways, door, gates, turnstiles, elevator, escalator, access/security monitoring system, reservation system, seat assignment system, Global Distribution Systems (GDS), travel ticketing system, boarding monitoring system, luggage tracking systems, centralized systems and/or data bases.

In a further aspect of the invention the inventive UID is readable by optical scanners, bar code readers and radio receivers.

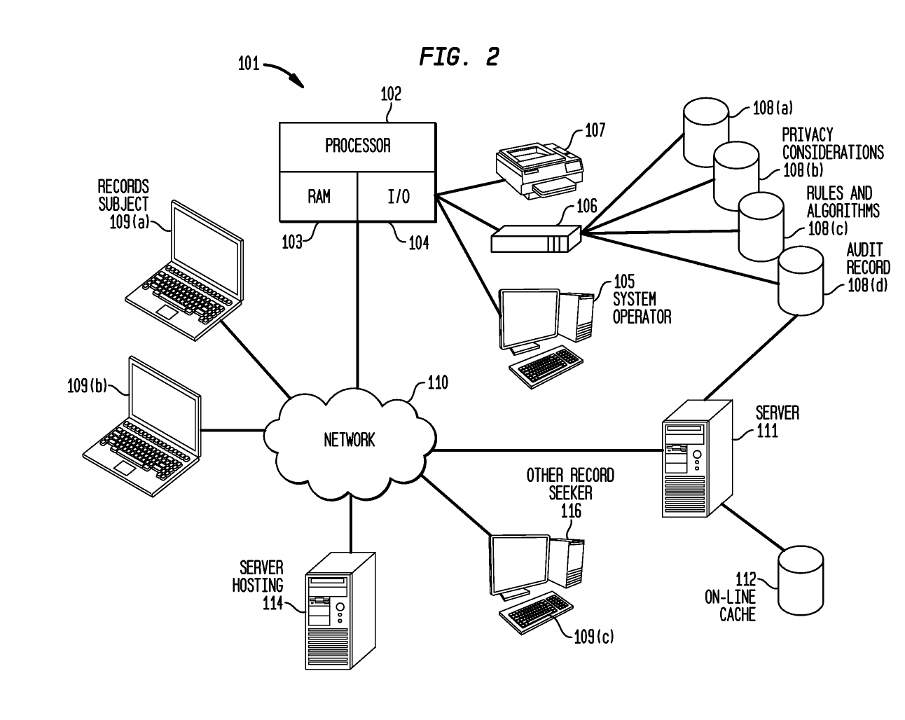

Now turning to the drawings, and more particularly to FIG. 2 thereof, it will be observed that it depicts the primary components of a system in accordance with the principles of the invention. Depicted therein are a digital data processor 101, including a processor section 102, a random access memory section 103, and an input/output control section 104. Digital data processor 101 is connected via input/output control section 104, to workstation 105 (including a monitor, keyboard and pointing device), one or more drives or alternative storage media 106 for storage of software and data, and printer 107. As shown, the software and data maintained on storage media 106 preferably includes a records identification database file 108(a); privacy considerations database file 108(b); rules and algorithms 108(c); and audit record 108(d). FIG. 2 also depicts an optional secure online cache 112 connected through server 111.

As depicted, digital data processor 101, as well as its sub-components 102-104, peripherals 105-107, related databases and/or software 108(a), 108(b), 108(c) and 108(d), server 111, and optional secure online cache 112, comprise the system managed and maintained by the system operator. The system operator's computer, along with other computers 109(a), 109(b) and 109(c) and may be interconnected via network 110 to file server 111 and have access to a web servers 114. As depicted, computer 109(a) comprises a representative workstation employed by an owner or user of the UID according to the invention; and computer 109(b) is illustrative of a representative workstation employed by an identification records administrator (i.e., a person responsible for content posted on the records database hosted on server 114). Computer 109(c) depicts a representative workstation employed by an instructional lost and found office, police or law enforcement department, security force or collectively referred to as “frequent finders” or person within a group who is responsible for identifying the owner or user of a lost or misplaced item. Computer 109(a) illustrates a representative workstation employed by an identification record holder or other person or entity holding information pertaining to the identification record. Even though in some case, such identification record holder may be the identification record holder themselves, either directly or through permitting access to his or her identification record, or may be one or more corporate, government or organizational groups to which the identification record belongs, these functions are nevertheless depicted separately in FIG. 1 for the purposes of illustrating the invention.

Persons of ordinary skill in the art should appreciate that the records pertaining to the identification records may be held in electronic form (e.g., as digital files or portions of electronic databases, etc.) and/or in hard copy form (e.g., as paper records, radiographic images, tape print-outs, and the like), with or without metadata associated therewith. As applicable, FIG. 2 shows records database 114 for storage of such electronic records and/or metadata of the identification record. Persons of ordinary skill in the art will appreciate that such data may be located on a single workstation within the records database 114 on a local computer, legacy system or data warehouse, and/or be resident on representative server 114 hosting a record identification for records holders or as a central databank repository for a community, country or region.

As shown, FIG. 2 also depicts a representative “other record seeker” 116, typically frequent finders described above, who may be included in yet another embodiment of the system. Such other record seeker may wish to request contact information of the owner or user of a UID. Persons of ordinary skill in the art should appreciate that such data may be de-identified in whole or in part by the system prior to making such records available for the foregoing purposes, and then forwarded to the appropriate person or entity by the system operator as part of adherence with various privacy and allowed access considerations.

Digital data processor 101, as well as its sub-components 102-104 and peripherals 105-107, may comprise a conventional commercially available personal computer or workstation adapted in accordance with the teachings herein for storing, accessing and processing data bases, rules and algorithms 108(a)-108(d). Computers 109(a)-109(d) and 116; servers 111, 114 and 115; and databases 112 and 113 may also comprise conventional commercially available components of their respective types. Network 110 may be, as a non-limiting example, the Internet or any alternative public and/or proprietary networks. Computers 109(a)-109(c) and 116 can likewise be adapted in accordance with the teachings within for viewing a browser for accessing programs and interacting with the system and other system users according to a system clock and rules database.

As should be appreciated by those skilled in the art, pertinent components needed for implementation of the system will vary corresponding to certain optional features, and the components identified in FIG. 2 are set forth for illustrative purposes and are not intended to suggest that all of such components and/or data are required in every instance in order to implement the principles hereof. For example, some of the parties for whom computer workstations and/or network connections are indicated in FIG. 2 will be utilized in various illustrative embodiments, and thus the computers and connections to these additional entities identified in FIG. 2 are set forth of illustrative purposes and are not intended to suggest that all of such workstations and connections are required in every instance in order to implement the principles hereof. Similarly, audit record 108(d) is optional and utilized in certain embodiments. Thus, although all of the elements of the system shown in FIG. 1 are not necessarily utilized in order to practice the principles of the invention and thus some of them are optional, it should be appreciated that each of the elements illustrated are attractive and add to the usefulness of the overall system.

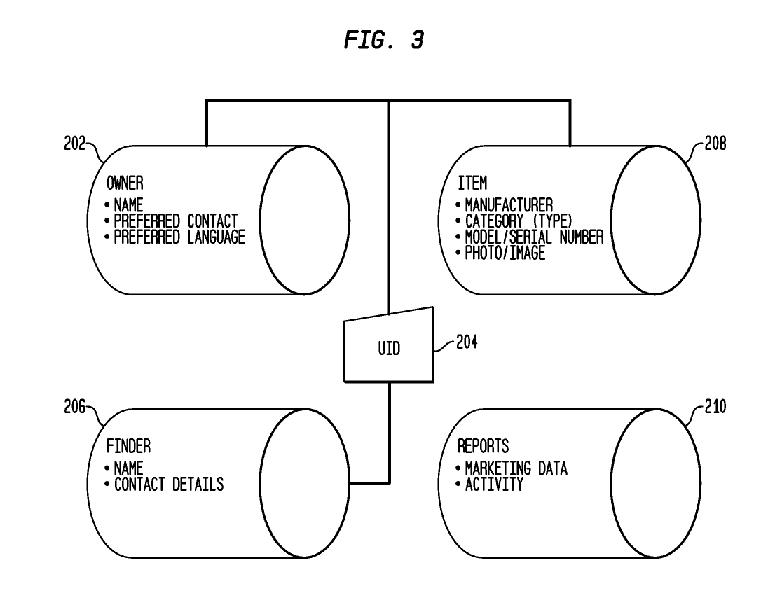

Another illustrative embodiment of the invention described with reference to FIG. 3 provides a system for identifying owners or users of the UID according to the invention. The system includes a database 204 including records associated with identification record owners or users. The records include information identifying contact information, inventory, language preference, handling instructions and/or other attributes of the identification record. An owner user interface 202 is configured to receive the information and to receive privacy preference settings from the owner or user of the identification record. A finder's interface 206 is configured to receive a search query identifying contact information or other attributes of an identification owner or user. A manufacturer's database 208 provides an owner or user identifying information to assist in the creation of the identification record. A search engine, which interfaces with the user interface 202 and optionally with the finder's interface 206, receives the search query and returns, from the database 208, a list of manufacturer's descriptive information matching a query.

In one illustrative embodiment of the present invention the system and method according to the invention may optionally contain privacy settings that indicate levels of access to the information contained within database 204. The privacy settings may be configurable by the identification record owners or user for each of a plurality of fields in the identification record. The privacy settings may be configurable by owners or user to allow selected fields to be viewed only by frequent finders or other designated information seekers. The selected fields may include means for contacting an owner or user of a UID while maintaining anonymity of said owner or user.

In another illustrative embodiment according to the invention a report generation interface 210 can retrieve selected data from the manufacturing data contained within the database. The report generation interface 210 can also generate reports related to the activity of requested information from both the owner interface 202 and the finder interface 206. It is also contemplated within the scope of the invention that owners and users can allow their contact information to be accessed to facilitate the receipt of offers and marketing materials from manufacturers and other marketing organizations.

In one embodiment, at the point of manufacture a UID according to the invention is affixed to baggage or luggage in a variety of ways including but not limited to the following: adhesive sticker, mounted identification plate, etching, and direct printing.

The UID identifies the brand or manufacturer of the specific item by model and color. In the case of baggage this can be the Simplified Baggage Identification Chart™. This is a variant of the IATA Baggage Identification Chart which reduces the identification structure from a minimum of seven characters to three.

After purchase, the new owner creates a user account on the system and registers the UID of the item within the created identification record. Based on the UID the identification record for the item can be pre-populated with basic details of the item. The owner can add additional items to the identification records including but not limited to owner contact information, inventory and handling instructions.

If found the finder is directed to a website to enter the UID which is validated to ensure it is both a valid UID and registered. If so, the finder is asked to provide details about where the found item is being held and how they can be contacted. In the case of a registered “frequent finder” such as an airport lost and found office, these additional details are already recorded and do not need to be entered again.

A message, via email, voice mail or text message is generated to the owner or user advising them that their item has been found and how to contact the finder. The identity of the owner is protected at the owner's instruction.

Within the identification record there is a field option allowing the owner the services of a “concierge” which is a licensed third party or carrier that will recover the item, package it and ship it to the owner at their expense.

In another illustrative implementation, at the point of manufacture a UID according to the invention is affixed to a computer or other electronic item in a variety of ways including but not limited to the following: adhesive sticker, mounted identification plate, etching, and direct printing.

The UID identifies the brand or OEM of the computer by model. After purchase, the new owner creates a user account on the system and registers the UID of the computer within the created identification record. Based on the UID the identification record for the computer can be pre-populated with basic details of the computer. The owner can add additional items to the identification records including but not limited to owner contact information and handling instructions in the event of the computer being lost or misplaced.

If found, the finder is directed to a website to enter the UID which is validated to ensure it is both a valid UID and registered. If so, the finder is asked to provide details about where the found computer is being held and how they can be contacted. In the case of a registered “frequent finder” such as an airport lost and found office, these additional details are already recorded and do not need to be entered again.

A message, via email, voice mail or text message is generated to the owner or user advising them that their computer has been found and how to contact the finder. The identity of the owner is protected at the owner's instruction.

Within the identification record there is a field option allowing the owner the services of a “concierge” which is a licensed third party or carrier (e.g. FedEx, UPS, DHL, etc.) that will recover the item, package it and ship it to the owner at their expense.

Although, as mentioned above, all of the features of the system are not required in order to practice the principles of the invention and thus some are optional, it is deemed apparent that each of the features illustrated in the accompanying drawings and the foregoing description are attractive and add to the usefulness of the invention. Likewise, certain steps of an embodiment which employs automated entry, calculation and/or reporting, may be conducted through manually written documents or semi-automatically though operation of the system processor and communication by modem, wired or wireless networking and the like.

As should be appreciated by persons who are skilled in the art, a well-ordered system may provide for the foregoing steps at any number of points in its operation. Accordingly, although these process steps are shown in the drawings and accompanying written description at particular points, it should be understood that this is illustrative only and does not suggest that some or all of these steps may not take place at other points during operation of the system. Similarly, although graphical user interfaces are contemplated that embody some or all of these features described herein, it should be understood that these interfaces are merely illustrative and should not suggest that some or all of these features may not be carried out using one or more different graphical user interfaces.

Additionally, although the disclosure hereof has been stated by way of example of illustrative embodiments, it will be evident that other adaptations and modifications may be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of this disclosure.

All publications and patent applications cited in this specification are herein incorporated by reference as if each individual publication or patent application were specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A system for identifying owners or users of misplaced or lost articles comprising:
a database including records associated with an identification record, wherein said identification record corresponds to an anonymous identifier for said identification record;
a user interface configured to receive said information and to provide preference settings within said identification record;
a finder interface configured to receive a search query identifying contact information and/or attributes of a identification record;
a search engine receiving said search query and returning a list of identification of owners or users of identification records matching said query from said database; and
a privacy engine configured with said search engine to restrict said list in accordance with said privacy settings.

2. The system of claim 1, wherein said privacy settings allow or prohibited the release of said contact information.

3. The system of claim 1, wherein said privacy settings are configurable by said owners or users of said identification records.

4. The system of claim 3, wherein said privacy setting are configurable by the use of a personal identification number.

5. The system of claim 1, wherein said list corresponds to an anonymous identifier for each identification record matching said search query.

6. A method for universal tracking identification comprising;
creating a unique identification number (UID) for an article,
corresponding said UID having with an identification record (IR), said IR having a plurality of data fields,
populating said data fields with descriptive information said descriptive information adaptable to global translation.

7. The system of claim 6, wherein said UID is an anonymous identifier for said identification record matching said search query.

8. The system of claim 7, wherein said UID comprises a manufacturers or issuers code, an item identifier, a serial number against an algorithm, and a check digits.

9. A system for identifying owners of articles comprising:
a database including records associated with identification records, wherein said records include information identifying contact information and/or attributes;
a user interface configured to receive said information and to provide preference settings within said identification record;
a finder interface configured to correspond with existing mass transit tracking systems to receive a search query identifying contact information and/or attributes of a identification record; and
a search engine receiving said search query and returning a list of identification of owners or users of identification records matching said query from said database.

10. The system of claim 9, wherein said identification records correspond with an anonymous identifier for said identification record.

11. The system of claim 9, wherein said anonymous identifier consists of elements selected from the group consisting of numbers, letters, words, symbols, colors and mixtures thereof.

12. The system of claim 10, wherein said identification records contain at least one field creating an inventory of said article.

13. The system of claim 9, wherein said anonymous identifier is optically identifiable.

14. The system of claim 9, wherein said anonymous identifier is readable by optical scanners, bar code readers and radio receivers.

15. The system of claim 9, wherein said user interface receives information and provides preference settings within said identification record through a web based system.
